(19) United States
(12) Patent Application Publication
(10) Pub. No.: US 2008/0260594 A1
(43) Pub. Date: Oct. 23, 2008

(54) Multiwell Plate

(75) Inventor: Klas Marteleur, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, UPPSALA (SE)

(21) Appl. No.: 12/090,267

(22) PCT Filed: Oct. 12, 2006
(86) PCT No.: PCT/SE06/01158

§ 371 Date: Apr. 15, 2008

(30) Foreign Application Priority Data
Oct. 18, 2005 (GB) 0521117.2

(51) Int. Cl. B01L 3/00

(52) U.S. Cl. 422/102

(57) ABSTRACT

Multiwell plate (21; 41) comprises a plurality of wells (23; 43) wherein each well (23; 43) has an open upper end (25; 45) and a lower end (27; 47) covered by a well bottom (28; 48), each lower end (27; 47) being provided with a through hole (29; 49) of diameter d mm, where d is greater then 0.5 mm and less than 3 mm, wherein each through hole (29; 49) is surrounded by a flat-topped wall (33; 53).

### FIELD OF THE INVENTION

The present invention relates to multiwell plates of the type mentioned in the preamble of the independent claim.

### PRIOR ART

Multiwell plates have been used for many years in laboratories for the simultaneous analysis of a number of samples. Typical formats include 4, 24, 48, 96 and 384 wells per plate. Initially, these plates had solid bases and liquid samples were pipetted into and out of the wells.

Subsequently, plates with wells provided with a lower well through hole (known as a “drip” if it is provided with downward protruding lips) pierced through the bottom surface. These multiwell plates allowed the samples to flow through the wells which permitted larger sample volumes to be processed (since the sample size was no longer limited to the capacity of the well).

Later developments of multiwell plates were provided with filter or membrane wells in which each well was provided with a microporous filter or membrane which extended over the cross-section of the well such that all of the sample passing through the well had to pass through the filter or membrane.

A further development of a multiwell plate comprises wells with a lower well through hole or drip and a filter or membrane and which wells are each at least partly filled with a media such as a chromatographic gel or slurry or chromatographic particles. In order to keep the media moist during storage, the wells are partly filled with a liquid and after filling the wells are sealed at both the upper and lower end to prevent the liquid escaping. A problem with such wells is that it is difficult to reliably seal both ends of the wells in an environmentally friendly fashion. It is known to seal the upper ends of wells with a film, usually made of a polymer and often laminated to an aluminium foil, which extends over substantially the whole of the surface area of the upper surface of the multiwell plate and which is attached to the material between the upper well through holes in the upper surface of the multiwell plate. Such a foil can be attached by an adhesive or by heat sealing. This involves providing a film with a surface which can be melted and which when melted forms a bond with the material from which the multiwell plate is made. Attempts to seal the drips at the lower ends of the wells using such foils have given unsatisfactory results as the adhesive or heat seal tends to partly or completely clog the through hole in the drip. Consequently the lower ends of wells have been sealed by providing a relatively thick mat or gasket of resilient material into which the drips can be pressed to form a fluid-tight seal. Such mats or gaskets needed to be attached to the multiwell plate by a support and the costs of the mat or gasket and its support is much higher than the cost of the film used to seal the other end of the wells. For sanitary lo reasons such mats or gaskets are intended to be used only once and then thrown away—consequently the use of gaskets generates a large volume of waste material.

### SUMMARY OF THE INVENTION

According to the present invention, at least some of the problems with the prior art are solved by means of a device having the features present in the characterising part of claim 1.

### BRIEF DESCRIPTION OF THE FIGURES

FIGS. 1a and 1b shows side and plane views of an example of a prior art multiwell plate;

FIGS. 2a)-2c) show perspective views including a partial cross-section of a first embodiment of a multiwell plate in accordance with the present invention;

FIG. 2d) shows an enlarged cross-section of the lower end of a well in accordance with the first embodiment of the present invention,

FIGS. 3a)-3c) show perspective views including a partial cross-section of a second embodiment of a multiwell plate in accordance with the present invention; and,

FIG. 3d) shows an enlarged cross-section of the lower end of a well in accordance with the second embodiment of the present invention.

### DETAILED DESCRIPTION OF EMBODIMENTS ILLUSTRATING THE INVENTION

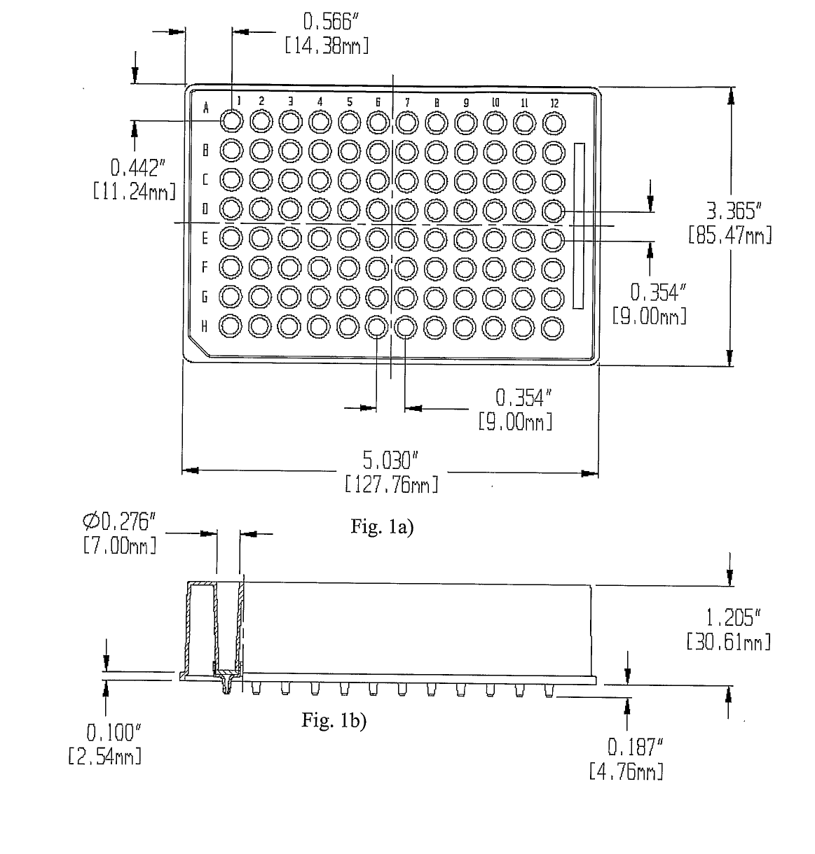

FIGS. 1a) and 1b) show an example of a prior art multiwell plate (1). Multiwell plate (1) comprises a rectangular body (2) provided with plurality of equally spaced cylindrical or tapered wells (3). Each well (3) has an open upper end (5) and a lower end (7). Each lower end (7) is provided with a through hole (9). In this example of a multiwell plate each through hole (9) is provided with a lip (11) which surrounds the through hole (9) and which protrudes away from the interior (13) of the well (3).

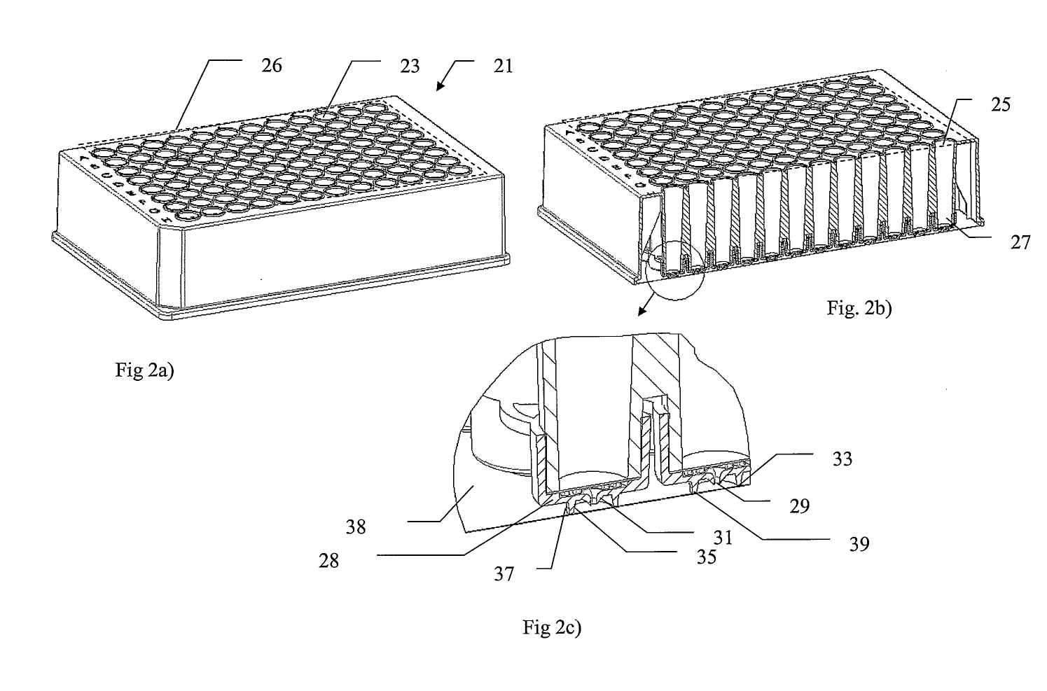

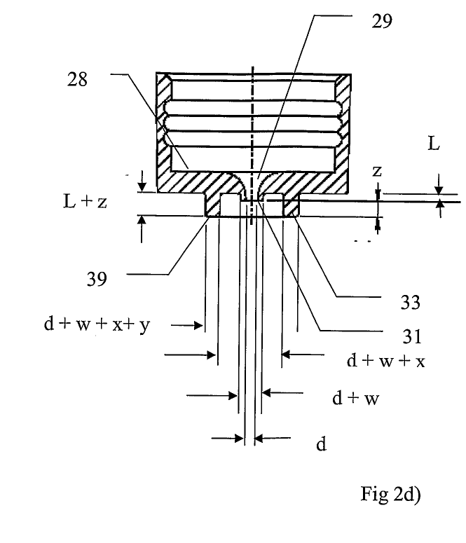

FIGS. 2a)-2d) show a first embodiment of a multiwell plate (21) in accordance with the present invention. Multiwell plate (21) comprises a plurality of wells (23). Each well (23) has an open upper end (25) (preferably covered by a foil or film (26) shown by a dashed line) and a lower end (27) covered by a well bottom (28). Each well bottom (28) is provided with a through hole (29) of diameter d mm, where preferably d is greater then 0.4 mm and less than 3 mm. In this embodiment of the present invention each individual through hole (29) is provided with a circular lip (31) which surrounds, and is substantially concentric with, its associated through hole (29). Each lip has a maximum diameter of (d+w) mm, preferably w is greater than 0.4 mm and less than 5 mm, and protrudes away from the interior of the well a maximum distance L mm from the outer surface (32) of the well bottom (28). Preferably L is from 0.1-2 mm. Each lip (31) is surrounded by a flat-topped, circular wall (33), each wall (33) preferably arranged to be substantially concentric with its associated lip (31).

Each wall (33) has an inner diameter of (d+w+x) mm and an outer diameter of (d+w+x+y) mm. Preferably x is greater than 1 mm and less then 5 mm. More preferably x is greater then 1.5 mm and less than 4 mm. Preferably y (which when the wall has a constant thickness corresponds to twice the wall thickness) is greater then 0.2 mm and less than 4 mm. More preferably y is greater then 1 mm and less than 2 mm.

Each wall protrudes away in the direction from the interior of the well (23) a distance of (L+z) mm from the well bottom (28). Preferably z is greater then 0.1 mm and less then 2 mm. More preferably z is greater than 0.2 mm and less than 1 mm. In this embodiment of the present both the inner surface (35) and outer surface (37) of a wall (33) are parallel to the longitudinal axis of the well (23) and the wall end surface (39) facing away from the well (23) is perpendicular to the longitudinal axis of the well (23).

The end surfaces (39) of each wall provide a surface to which a suitable sealing membrane such as a foil or film (38) can be attached. Preferably the sealing membrane comprises at least one layer of a material which, when heated and pressed against the lo wall end surface (39), forms a seal with the material of the wall end surface which is fluid-tight after it has cooled. Alternatively at least one of the surface of the membrane, foil or film (38) facing towards wall end surface (39), and/or wall end surface (39) is made adhesive.

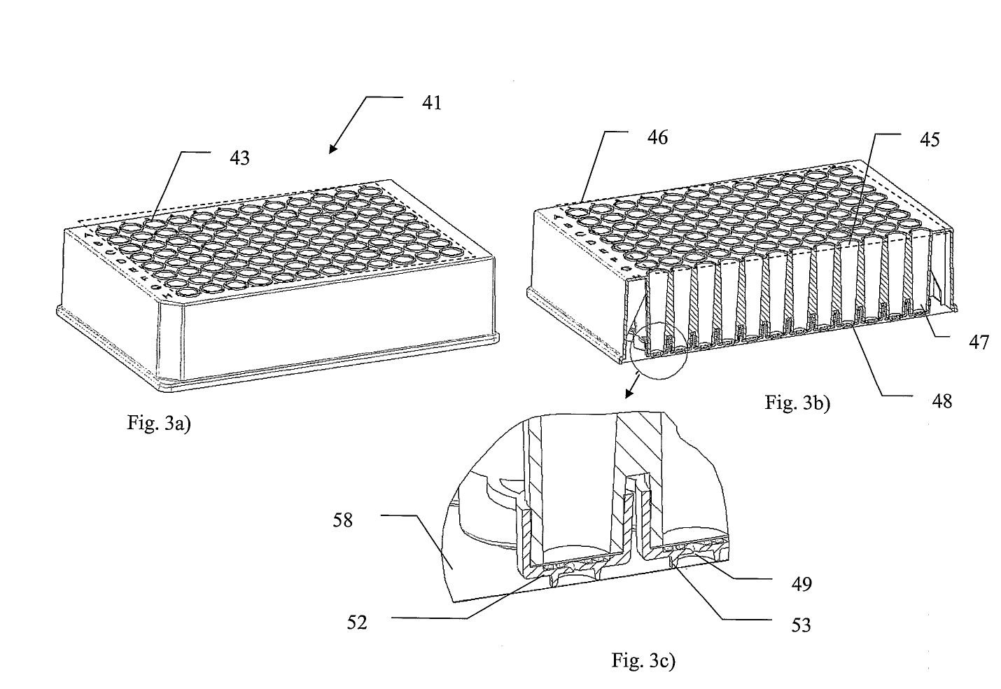

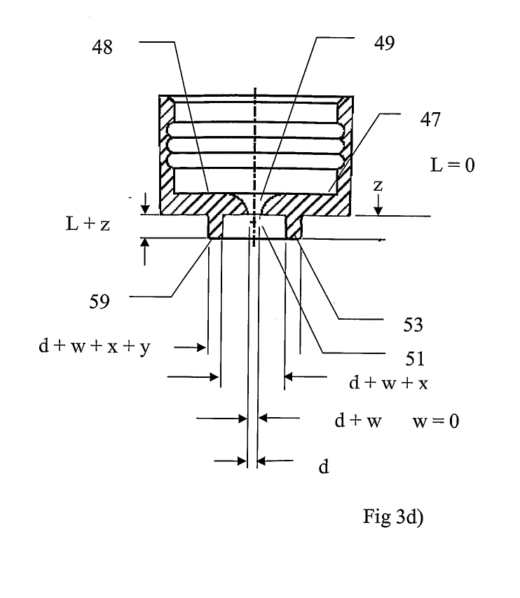

FIGS. 3a)-3d) show a second embodiment of a multiwell plate (41) in accordance with the present invention. Multiwell plate (41) comprises a plurality of wells (43). Each well (43) has an open upper end (45) (preferably covered by a foil or film (46) shown by a dashed line) and a lower end (47) covered by a well bottom (48). Each well bottom (48) is provided with a through hole (49) of diameter d mm, where preferably d is greater then 0.4 mm and less than 3 mm. In this embodiment of the present invention each individual through hole (49) is not provided with a circular lip, consequently the distance L is zero mm and the distance w is zero mm. Each through hole (49) is surrounded by a flat-topped, circular wall (53) which projects away from the outer surface (52) of its associated well bottom (48), each wall (53) preferably being arranged to be substantially concentric with its associated through hole (49).

Each wall (53) has an inner diameter of (d+w+x) mm and an outer diameter of (d+w+x+y) mm where w=0 mm. Preferably x is greater than 1 mm and less then 5 mm. More preferably x is greater then 1.5 mm and less than 4 mm. Preferably y (which when the wall has a constant thickness corresponds to twice the wall thickness) is greater then 0.2 mm and less than 4 mm. More preferably y is greater then 1 mm and less than 2 mm.

Each wall (53) protrudes away from the interior of the well (43) a distance of (L+z) mm—in this embodiment L being zero mm. Preferably z is greater then 0.1 mm and less then 2 mm. More preferably z is greater than 0.2 mm and less than 1 mm. In this embodiment of the present both the inner surface (55) and outer surface (57) of a wall (53) are parallel to the longitudinal axis of the well (43) and the wall end surface (59) facing away from the well (43) is perpendicular to the longitudinal axis of the well (43).

The end surface (59) of each wall provides a surface to which a sealing membrane such as foil or film (58) can be attached. Preferably the sealing membrane comprises at least one layer of a material which, when heated and pressed against the wall end surface (59), lo forms a seal with the material of the wall end surface which is fluid-tight after it has cooled. Alternatively at least one of the surface of the membrane, foil or film (58) facing towards wall end surface (59), and/or wall end surface (59) is made adhesive.

While the present invention has been illustrated by examples of embodiment in which the walls are circular it is conceivable to have walls of any shape, for example, quadratic, hexagonal, octagonal, etc. In the case of non-circular walls where it is not possible to talk about the inner or outer diameter of the wall, then each wall is preferably arranged to a minimum proximity of (w+x)/2 mm from its associated through hole and to have a wall thickness of y/2 mm.

Additionally, it is conceivable to have walls in which the outer and inner surfaces instead of being perpendicular to the longitudinal axis of the well are tapered such that the thickness of the wall decreases as it extends way from the well.

The above mentioned embodiments are intended to illustrate the present invention and are not intended to limit the scope of protection claimed by the following claims.

1: A multiwell plate (21; 41) comprising:
a plurality of wells (23; 43) wherein each well (23; 43) has an open upper end (25; 45) and a lower end (27; 47) covered by a well bottom (28; 48), each lower end (27; 47) being provided with a through hole (29; 49) of diameter d, where d is greater then 0.4 mm and less than 3 mm, wherein:
each through hole (29; 49) is surrounded by a flat-topped wall (33; 53);
each wall (33; 53) has a minimum proximity of (w+x)/2 mm to its associated through hole (29; 49), wherein w is equal to zero mm or is greater than 1 and less than 5 mm, and x is greater than 1 mm and less then 5 mm; wherein each wall projects a distance (L+z) mm from its associated lower end (27; 47), wherein L is equal to 0.1 mm or is greater than 0.1 mm and less than 2 mm, and z is greater than 0.1 mm and less than 2 mm; and
each wall (33; 53) having a wall end surface (39; 59) and a membrane (38; 58) is joined in a fluid-tight seal to the wall end surfaces (39; 59).

2: The multiwell plate of claim 1, wherein x is greater than 1.5 mm and less then 4 mm.

3: The multiwell plate of claim 1 wherein the wall thickness is y/2 mm where y is greater than 1 mm and less than 4 mm.
